(19) United States
(12) Patent Application Publication
(10) Pub. No.: US 2009/0072580 A1
(43) Pub. Date: Mar. 19, 2009

(54) INTEGRATED VALVE/CYLINDER DEVICE

(76) Inventor: Robert S. Wojtach, JR., Indianapolis, IN (US)

Correspondence Address: BOSE MCKINNEY & EVANS LLP, 111 MONUMENT CIRCLE, SUITE 2700, INDIANAPOLIS, IN, 46204, US

(21) Appl. No.: 11/855,173

(22) Filed: Sep. 14, 2007

(51) Int. Cl. E05F 15/04; B60J 5/04

(52) U.S. Cl. 296/146.4; 49/265

(57) ABSTRACT

An integrated valve/cylinder device to move a barrier from a closed to an open position in response to a fluid pressure provided by a fluid supply. The valve/cylinder device includes a manifold to couple the valve to the cylinder.

### BACKGROUND

Doors, gates, or other barriers permit or block access to buildings, vehicles, or other property. Such barriers often include devices to open or close the barriers. The devices can be either mechanical or electro-mechanical devices which are typically coupled to the barrier and to a stationary or anchoring structure to enable opening and closing of the barrier. In the case of doors used with a building, the anchoring structure typically includes a wall of the building. In the case of a gate used to block access or to permit access to property, the anchoring structure can be a portion of a fence which surrounds the property. In the case of a vehicle, the anchoring structure can be a portion of the vehicle which is relatively stable and sturdy to permit opening and closing of the door.

When a mechanical device is used to open and to close a barrier, such as a door, the mechanical device typically provides mechanical assistance to open or close the door. In this situation, the door is typically heavy and requires a mechanical assistance to enable a person to open or to close the door more easily. Such mechanical devices include pneumatic cylinders. For other barriers, electro-mechanical devices are preferred. An electro-mechanical device is controlled by a user, typically through the use of a switching device or a computer control device, which can open or close the barrier upon receipt of a signal. Electro-mechanical devices can be used where barriers are too heavy to be moved by a person or where it is preferred that the barrier can only be opened through control of an electrical signal whose generation can be controlled by a person or device such as an electric sensor.

Where vehicles are concerned, and particularly for doors of buses used for the transportation of the public, for students or others, it is known to couple one end of a cylinder to a portion of the bus and an opposite end of the cylinder to the door. In some instances, a mechanical linkage system is used and the door is opened purely under the control of a mechanical force typically generated by a bus driver. In other instances, doors are opened by an electro-mechanical device which responds to an electrical signal typically generated by a bus driver through the activation of a switch. The electro-mechanical device in the bus can include a pneumatic cylinder coupled to a valve or valving apparatus. An electrical portion of the valve and cylinder assembly includes a lead wiring harness or flying lead wiring harness located between and coupled to the valve and the cylinder. The flying lead wiring harness includes a plurality of exposed individual wires. Such harnesses can suffer from vehicle vibration which can lead to failure of the electrical connectors and to the wires which couple the valving apparatus of the cylinders. Flying lead wiring harnesses can also suffer breakage resulting from stresses occurring during installation.

Other known designs include a valve/cylinder combination that utilizes a one piece aluminum construction. In this construction, two pneumatic valves with a flying lead wiring harness are included to operate the assembly.

Such electro-mechanical devices also utilize pipe nipples, fittings, and tubing to connect a body ported pneumatic valve to a pneumatic cylinder. Because fitting and flow controls are installed in ports of the valve body to control supply and exhaust air to the cylinder, such an application requires electrical actuation using the flying electrical leads. Consequently, known electro-mechanical devices used to move a barrier can suffer repeated failures.

### SUMMARY

The present invention includes an electro-mechanical assembly or device for moving a barrier from a first position to a second position. The present invention can be used to move a barrier, such as gates and doors to vehicles, including automobiles, buses, trucks, and airplanes. In particular, the present invention includes a fluid cylinder coupled to a valve through a manifold for opening and closing a door on a vehicle. The integrated valve/cylinder device incorporates the components of electrical lead wires into a manifold which is adapted to couple to a cylinder and to a plug-in style solenoid valve. The manifold provides for connection to a supply line of an air compressor, flow controls, and pneumatic porting to the cylinder. In addition to incorporating a plug-in style solenoid valve into the assembly, electrical wiring coupled to the valve terminates at an accessible electrical housing connection for coupling to a connector supplied by an end user or customer. In the case of a bus for instance, the bus manufacturer provides an electrical coupler or connector which is coupled to a control device, such as a switch, which can provide a signal to open and close the vehicle door.

To incorporate a plug-in solenoid valve, various fittings, various flow controls, and pneumatic porting to a cylinder, the manifold includes extend and retract ports which are coupled to the cylinder. A mounting area on the head and rod cover of the cylinder are machined to include a flat such that the manifold can substantially seal to the cylinder. Mounting bolts and O-rings are used to couple the manifold to the cylinder. Because the manifold can be removed from the cylinder by removing the mounting bolts, the present invention provides a modular system which can be advantageous should the cylinder fail. The manifold, including the valve and other components attached thereto, can be removed from the failed cylinder and attached to a functioning cylinder.

The manifold includes a plurality of apertures to enable the mounting of a plug-in style solenoid valve. The electrical portion of the valve can be coupled to an accessible connector through the interior or non-exposed portions of the manifold. An end user specified electrical housing assembly can be held in place by utilizing two roll pins. The present invention can eliminate wiring exposed to the outside environment and enables the electrical connector housing to be replaced if desired.

Internal porting through the manifold can route supply and exhaust air to and from the cylinder. Internal porting included in the manifold provides for access to the supply port and flow controls. The supply port is coupled to a supply of pressurized air, in the case of the bus, and the flow controls enable control of the amount of pressurized fluid available for the retraction or extension of the cylinder rod. A top portion of the manifold includes inclined surfaces which can provide improved accessibility for installation of the supply line as well as for access to the flow controls, connector, and valve.

The integrated valve/cylinder device can incorporate a pneumatic plug-in valve, a connector, one pneumatic fitting, and two flow controls coupled with a pneumatic cylinder through a manifold assembly. An end user can mount the entire assembly in place using the eyes at either end of the cylinder, install a single supply line, and connect a mated or mating electrical connector or housing to the completed device for regular service.

According to one aspect of the present invention, there is provided a device to move a vehicle door from a closed to an open position in response to a fluid pressure provided by a fluid supply. The device includes a pneumatic cylinder including an extension port and a retraction port and a manifold is coupled to the pneumatic cylinder. The manifold includes a first opening adjacent the extension port, a second opening adjacent the retraction port, and a fitting adapted to couple to the fluid supply.

According to another aspect of the present invention, there is provided a device to move a vehicle door from a closed to an open position in response to a fluid pressure provided by a fluid supply. The device includes a pneumatic cylinder including an arm, the arm being movable from a first position to a second position, and a manifold coupled to the pneumatic cylinder. The manifold includes a first flow control to control movement of the arm from the first position to the second position, a second flow control to control movement of the arm from the second position to the first position, and a fitting, adapted to couple to the fluid supply.

### BRIEF DESCRIPTION OF THE DRAWINGS

FIG. 1 illustrates a partial perspective schematic view of an interior of a moving vehicle including a valve/cylinder device of the present invention.

FIG. 2 illustrates an elevational perspective view of a valve/cylinder device of the present invention.

FIG. 3 illustrates an elevational perspective exploded view of a valve/cylinder device of the present invention.

FIG. 4 illustrates an elevational perspective view of a first side of a manifold of the present invention.

FIG. 5 illustrates an elevational perspective view of a second side of the manifold of FIG. 4.

### DETAILED DESCRIPTION OF THE DRAWINGS

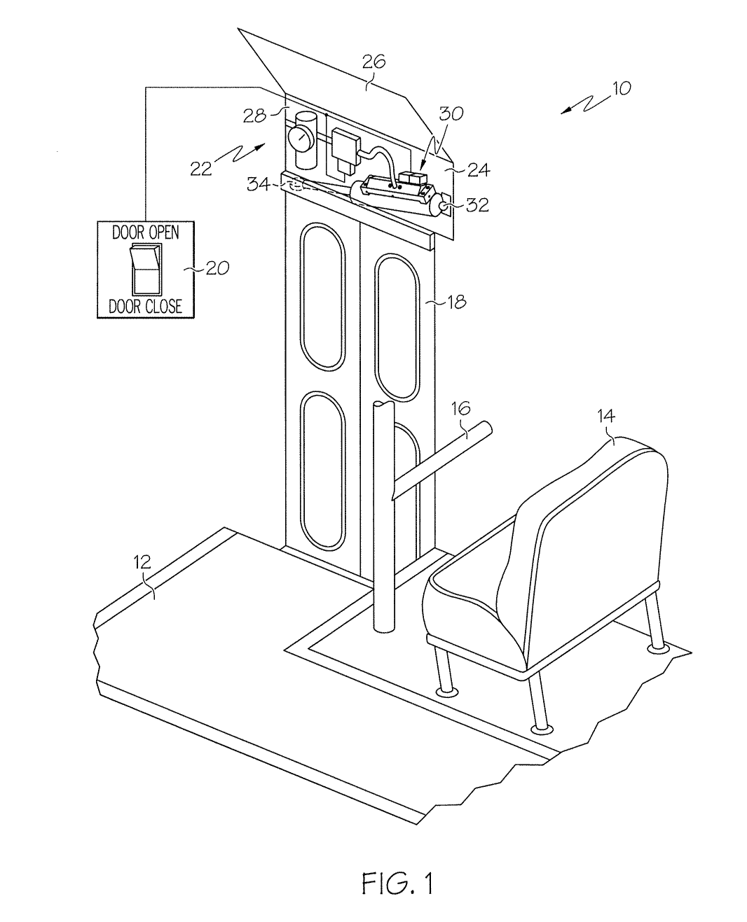

FIG. 1 illustrates an interior portion 10 of a vehicle to carry passengers. The vehicle can include a bus or any other known vehicle for transportation. The vehicle includes a floor 12, a seat 14 coupled to the floor 12, and a rail 16. The rail 16 provides a barrier between the seat 14 and a door 18. The door 18 can be opened or closed by a switch 20 as is understood by those skilled in the art. The door 18 is opened and/or closed through a door moving system 22 which is located in a cavity 24. The cavity 24 can be hidden from view by an access panel 26 which can be placed in either an open position (shown) to provide access to the door moving system 22 or a closed position to hide the door moving system.

The door moving system 22 includes an air pressure regulator/controller 28 as is understood by those skilled in the art. The air pressure regulator/controller 28 is coupled to an integrated valve/cylinder device 30 of the present invention. The air pressure regulator/controller 28 is coupled to an air tank (not shown) which supplies a pressurized air to the door moving system 22 as is understood by those skilled in the art. The integrated valve/cylinder device 30 includes a first end 32 coupled to a portion of the vehicle and a second end 34 coupled to a door mechanism, as is understood by those skilled in the art, to open and close the door 18.

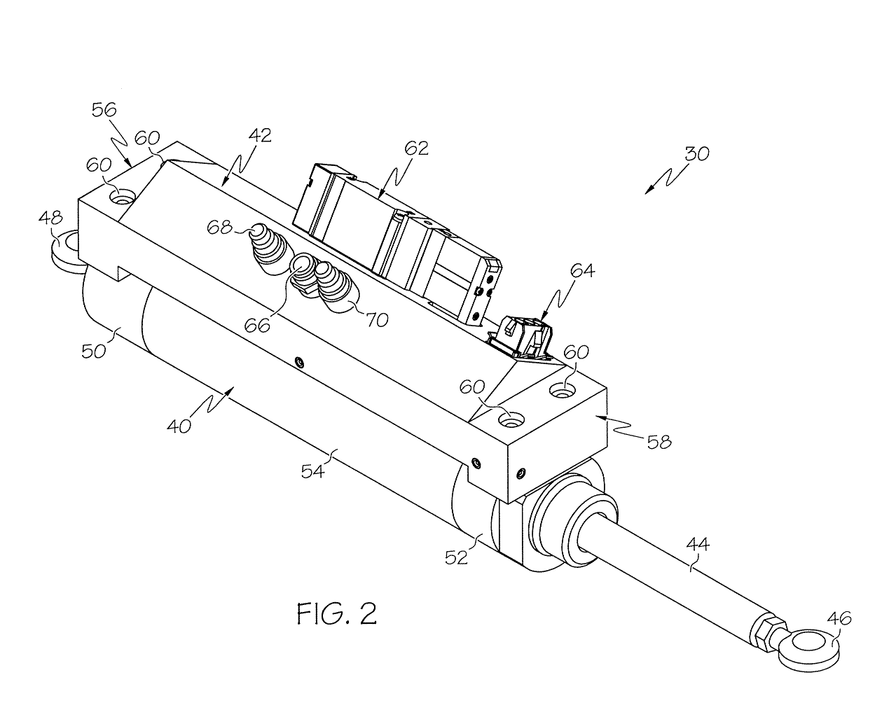

As illustrated in FIG. 2, the integrated valve/cylinder device 30 includes a cylinder 40 which is coupled to a manifold 42. The cylinder 40 includes an extending rod 44 having a rod eye 46 coupled thereto. At an opposite end of the cylinder 40 is a second eye 48. The eye 48 corresponds to the first end 32 and the rod eye 46 corresponds to the second end 34 as previously described in FIG. 1.

The manifold 42 is coupled to a first end cap 50 and a second end cap 52. The end caps 50 and 52 are coupled to a cylinder housing 54 as is understood by those skilled in the art. The manifold 42 is coupled to the first end cap 50 and second end cap 52 at a first end 56 and a second end 58 of the manifold respectively. The first end 56 and the second end 58 each include one or more apertures 60 which are adapted to receive connectors, such as screws and/or bolts, which couple the manifold 42 to the first and second end caps 50 and 52 respectively.

The manifold 42 includes a plurality of apertures adapted to receive a control valve 62, an electrical connector 64, a fluid connector 66, a first flow control device 68 and a second flow control device 70. The fluid connector 66 can be coupled to an air line which is provided at the air pressure regulator/controller 28 of FIG. 1. The first and second flow control devices control the amount of air pressure or air flow used to control the extension and retraction of the rod 44 to open and close the door 18. The control valve 62 is coupled to the electrical control connector 64 through internal wiring (not shown). The electrical control connector 64 is adapted to couple to an electrical connector provided by the vehicle manufacturer such that the switch 20 can be used to open and close the door 18. The electrical connector 64 can include wires carrying control signals and/or electrical power.

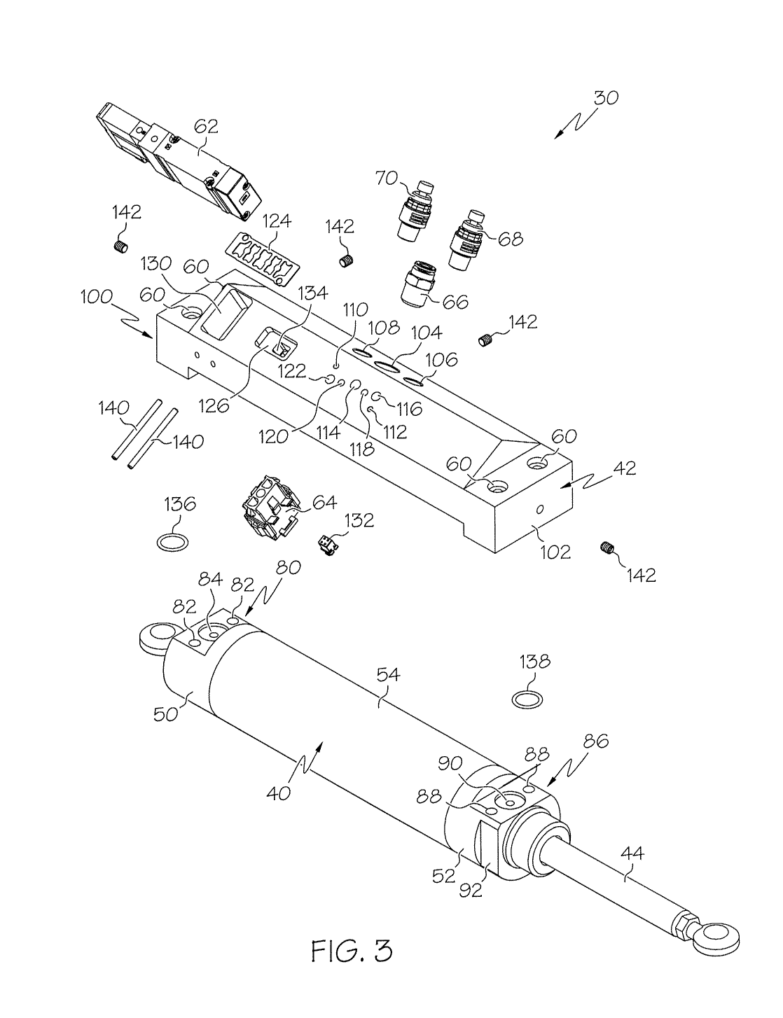

FIG. 3 illustrates an exploded elevational perspective view of the integrated valve cylinder device 30. The cylinder 40 includes as previously described a first end cap 50 and a second end cap 52. The first end cap 50 is formed to include a first mounting area 80 as well as first and second mounting holes 82 adapted to receive a connector as previously described. The first mounting area 80 also includes an extension port 84. The extension port 84 receives a pressurized fluid, such as air, to extend the rod 44 once it has been retracted. The mounting area 80 includes a flat surface or flat which is substantially planar and which is adapted to receive a portion of the manifold 42. The second end cap 52 includes a second mounting area 86 as well as mounting holes 88 and retraction port 90. The retraction port 90 receives pressurized fluid, such as air, to retract the rod 44 into the cylinder tube 54. The mounting area 86 includes a flat area, also known as a flat, which is substantially planar to receive a portion of the manifold 42. An additional flat 92 is located on the second end cap 52 and is provided for machining of the flat as is understood by those skilled in the art. A similar flat is included on end cap 50.

The manifold 42 includes a first end 100 which can be coupled to the mounting area 80 and a second end 102 which can be coupled to the mounting area 86. The manifold 42 further includes a fluid connector aperture 104 and first and second flow control apertures 106 and 108. The fluid connector aperture 104 is adapted to receive and to hold the connector 66. The first and second flow control apertures 106 and 108 respectively are adapted to receive the flow controls 68 and 70.

The control valve 62 is coupled to the manifold 42 with connectors (not shown) at a first mounting aperture 110 and a second mounting aperture 112. The manifold further includes a supply line aperture 114, an exhaust aperture for retract 116, a retract aperture 118, an extend aperture 120 and an exhaust aperture for extend 122. The apertures 114, 116, 118, 120, and 122 are arranged at a predetermined spacing to align with corresponding apertures, connectors, or fittings located on the control valve 62 as is understood by those skilled in the art. Control valve 62 can include a 2 position single solenoid valve having an integrated electrical plug or connector. One such valve is available from SMC Corporation of America having the part number SV2200-6FU. A gasket 124 is located between the control valve 62 and the manifold 42 to substantially prevent the leakage of air at the valve/manifold interface. A control valve connector aperture 126 is adapted to receive an electrical connector which is located on the control valve 62.

An aperture 130 sized to accept connector 64 is located on the manifold 42. An internal connector 132 is located in an aperture 134 of the manifold and is used to couple a wiring harness (not shown) which extends from the internal connector 132 to the connector 64.

First and second O-rings 136 and 138 respectively are located in extend port 84 and retract port 90 to provide for a substantially air tight seal between the cylinder 40 and the manifold 42. Roll pins 140 couple the connector 64 to the manifold. Expansion plugs 142 are used to seal the manifold as is understood by those skilled in the art.

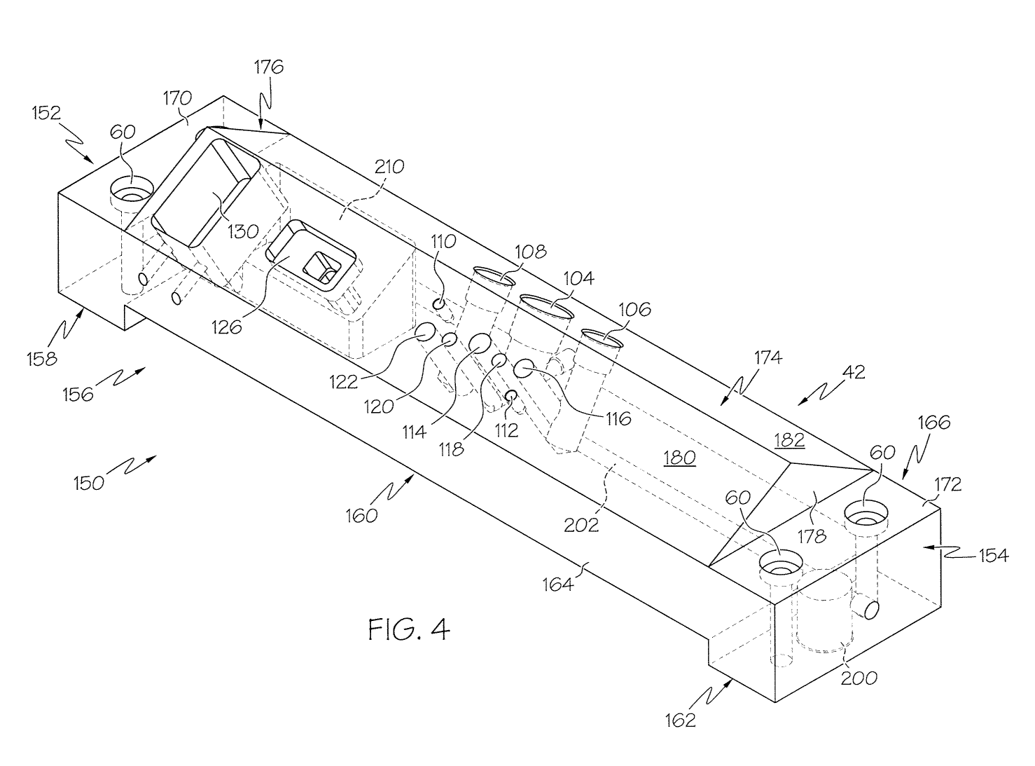

FIG. 4 illustrates a perspective elevational view of the manifold 42 from a first side 150. The manifold 42 includes a first end wall 152 spaced a predetermined distance from a second end wall 154. The predetermined distance is substantially the same as the distance between the distal ends of caps 50 and 52. A bottom portion 156 includes a bottom wall 158, a bottom wall 160, and a bottom wall 162. The bottom wall 158 and bottom wall 162 are separated by the bottom wall 160 which includes a surface offset from the surfaces of the bottom walls 158 and 162. The surfaces of the bottom wall 158 and 162 contact respectively the first mounting area 80 and the second mounting area 86 of FIG. 3 when the manifold 42 is coupled to the cylinder 40. A first side wall 164 and a second side wall 166 are spaced a predetermined distance apart and cooperate with the first and second end walls and the bottom walls to form a portion of the manifold 42. First and second top portions 170 and 172 define previously described apertures 60 which provide for coupling of the manifold to the cylinder 40.

Disposed between the first and second portions 170 and 172 is a mounting portion 174. The mounting portion 174 is defined by first and second triangular shaped end walls 176 and 178. Disposed between the first and second end walls 176 and 178 and terminating therewith are first and second mounting surfaces 180 and 182. First mounting surface 180 includes the previously defined apertures 110, 112, 114, 116, 118, 120, 122, 126, and 130. The second mounting surface 182 includes previously defined apertures 106, 104, and 108. It is within the scope of the present invention to arrange the apertures in a different configuration to meet end user or customer requirements. Because the mounting area 174 is defined by triangular shaped end walls 178, the mounting surfaces 180 and 182 are disposed such that the surfaces are not parallel with either of the side walls 164 and 166 or the end walls 152 and 154. Consequently, by creating the mounting area 174 which is neither perpendicular to nor parallel to certain other walls of the manifold, the mounting area provides for improved access to at least one of the electrical connectors, the control valve 62, the connector for the supply line, or the retract or extend controls. Consequently, by providing a mounting surface which extends away from and is inclined with respect to the first and second portions 170 and 172 difficulty of access to the various modules and controls located on the mounting areas can be reduced.

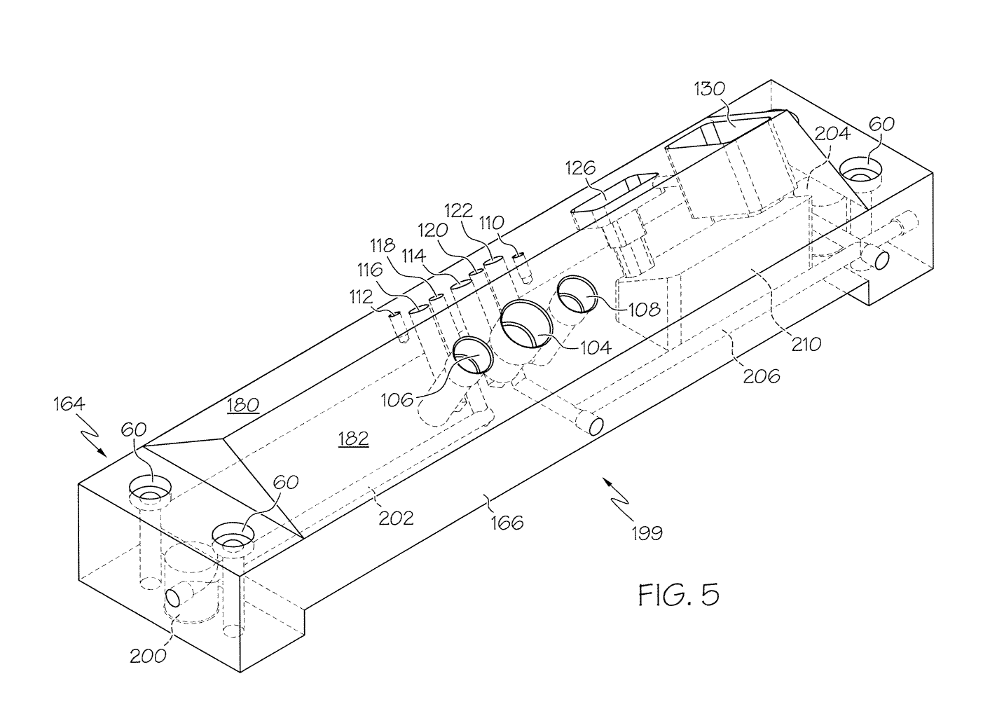

FIG. 4 and FIG. 5 further illustrate the internal channels of the manifold 42 which provide an integrated valve/cylinder device of the present invention. FIG. 5 illustrates a perspective elevational view of a second side 199 of the manifold 42 of FIG. 4. A retract port or opening 200 which interfaces with the retract port 90 of the cylinder 40 is coupled to the retract port 118 through a channel 202. Furthermore, exhaust 116 is coupled to the retract control aperture 106. The supply line aperture 114 is coupled to the air line aperture 104. The extend port 120 interfaces with and is coupled to an extend port 204 of the manifold through a channel 206, as seen in FIG. 5. The extend port or opening 204 also interfaces with and is coupled to the extension port 84 when the manifold is coupled to the cylinder. An electrical wiring harness cavity 210 can be seen in both FIG. 4 and FIG. 5 where it is adapted to hold a wiring harness which connects the control valve electrical connector disposed in the valve electrical cavity 126 to the vehicle electrical connector 64 disposed in the electrical connector cavity 130. The aperture 210 can be open such that the wiring harness is left exposed if the manifold is removed from the cylinder 40. The aperture 210 can also be substantially enclosed with a plate or other barrier either coupled to the manifold or formed therein.

The manifold can be made of any number of materials including metal and/or plastics. To reduce weight, the manifold can be made of aluminum while other metals such as steel or iron can also be used. In addition, a variety of plastics can also be used such as phenolic and/or PVC materials. While it is preferred to have the mounting areas 174 inclined for access, such an arrangement is not necessary. For instance, the mounting areas 174 can be disposed parallel to the first side wall 164 and the second side wall 166 such that the connectors and/or controls located therein would be substantially perpendicular to the surfaces of side wall 164 and 166.

Although the invention has been described in detail with reference to preferred embodiments, variations and modifications exist within the scope and spirit of the invention as described and defined in the following claims. For instance, the present invention is not limited to opening a door, but can be used to open other vehicle access doors, such as trunk lids, hoods, and storage compartment doors.

1. A device to move a vehicle door from a closed to an open position in response to a fluid pressure provided by a fluid supply, the device comprising:
a pneumatic cylinder including an extension port and a retraction port; and
a manifold, coupled to the pneumatic cylinder, the manifold including first opening adjacent the extension port, a second opening adjacent the retraction port, and a fitting, adapted to couple to the fluid supply.

2. The device of claim 1, wherein the pneumatic cylinder includes a first mounting area and a second mounting area, the first mounting area to provide a first interface between the first opening and the extension port, and the second mounting area to provide a second interface between the second opening and the retraction port.

3. The device of claim 2, wherein at least one of the first mounting area and the second mounting area comprise a flat.

4. The device of claim 3, wherein the first mounting area and the second mounting area each comprise a flat.

5. The device of claim 4, further comprising a first seal located at the first interface to substantially prevent leakage therebetween.

6. The device of claim 5, further comprising a second seal located at the second interface to substantially prevent leakage therebetween.

7. The device of claim 6, wherein the first seal comprises an o-ring.

8. The device of claim 7, wherein the second seal comprises an o-ring.

9. The device of claim 1, further comprising a valve coupled to the manifold.

10. The device of claim 9, further comprising an electrical connector coupled to the manifold.

11. The device of claim 10, wherein the valve comprises a solenoid valve including an integrated electrical connector.

12. The device of claim 11, wherein the electrical connector coupled to the manifold includes a dimension selected to couple to an electrical connector provided with the vehicle.

13. The device of claim 12, further comprising a valve electrical connector to mate with the integrated electrical connector, the valve electrical connector being disposed between the electrical connector coupled to the manifold and the integrated electrical connector.

14. A device to move a vehicle door from a closed to an open position in response to a fluid pressure provided by a fluid supply, the device comprising:
a pneumatic cylinder including an arm, the arm being movable from a first position to a second position; and
a manifold, coupled to the pneumatic cylinder, the manifold including a first flow control to control movement of the arm from the first position to the second position, a second flow control to control movement of the arm from the second position to the first position, and a fitting, adapted to couple to the fluid supply.

15. The device of claim 14, wherein the pneumatic cylinder further comprises an extension port to extend the arm from the first position to the second position and a retraction port to retract the arm from the second position to the first position.

16. The device of claim 15, wherein the manifold further comprises a first opening adjacent the extension port, a second opening adjacent the retraction port.

17. The device of claim 16, further comprising an electrical connector coupled to the manifold, the electrical connector including a dimension selected to couple to an electrical connector provided with the vehicle.

18. The device of claim 17, wherein the manifold further comprises an aperture having a size selected to receive a portion of a valve.

19. The device of claim 18, wherein the portion of the valve comprises a valve electrical connector.

20. The device of claim 19, wherein the manifold includes at least one mounting feature, the mounting feature adapted to removably mount the valve to the manifold.
